(19) United States
(12) Patent Application Publication
(10) Pub. No.: US 2003/0066164 A1
(43) Pub. Date: Apr. 10, 2003

(54) Adjustable door hinge

(76) Inventor: Georg Domenig, Kernersville, NC (US)

Correspondence Address: Charles Y. Lackey, Post Office Box 5871, Winston-Salem, NC, 27113-5871, US

(21) Appl. No.: 09/973,223

(22) Filed: Oct. 9, 2001

(51) Int. Cl. E05D 7/04

(52) U.S. Cl. 16/237

(57) ABSTRACT

An adjustable door hinge for joining a combination of doors maintained by an adjacent structure having a hinge cup and a hinge arm movably attached to the hinge cup. A base plate secured to one of the doors or an adjacent structure has a fixed hinge arm engaging member with upstanding side walls which is adjustable secured to the hinge arm. The hinge arm engaging member has an elongated slot and is movable linearly with respect to the hinge arm to permit adjustment of a joined door combination. The hinge aim and hinge arm engaging member are joined together by an appropriate threaded fastener.

### BACKGROUND OF THE INVENTION

1. Field of the invention. The present invention is for a door hinge and more particularly for a adjustable door binge used to join a combination of doors to a supporting structure. Adjustable recess hinges are known in the art and generally comprise a hinge cup which can be fixed in a bore of either a door member or a supporting frame member, a separate mounting plate fixed to the other of door or supporting frame member, a separate intermediate adjusting part or parts connectable to either or both of the hinge cup and the mounting plate, and a hinge arm interconnectable between intermediate adjusting part or between an intermediate adjusting part and either of the hinge cup or the mounting plate.

In such devices, the hinge cup is dimensioned to snugly fit into the bore, for example, of a door and is adapted to be secured against displacement within the bore relative to the door and the mounting plate as likewise adapted to be fixed, for example, to a supporting frame and secured against displacement relative to the supporting frame. Adjustment or repositioning of the mounted door relative to the supporting frame is provided by one or more separate intermediate adjusting parts which include arrangements of plates, blocks and the like that are slideable in groves, channels or the like and clamped, for example, with one or more set screws.

A particular kind of adjusting frame is needed to connect to doors in a side-by-side and movable relationship with respect to each other which can be used, for example, at the comer formed where two cabinets intersect at 90 degree angle. Prior art utilized to form such a junction between two movable doors are complicated and expensive, usually requiring a number of adjustments at different locations throughout the hinge assembly in order to refine the door configuration. Some prior art devices include a snap on cover for the base plate which, when snapped off expose a number of adjusting screws that enable a two part hinge assembly to be moved incrementally so as to make an appropriate door adjustment. Thus there is a need for a less expensive, less complicated, more installer and adjuster friendliness, and it is to these needs that the present invention is directed.

### SUMMARY AND OBJECTIVES OF THE INVENTION

The present invention overcomes the problems associated with prior art devices and provides an adjustable hinge for joining two side-by-side movable door members which is simple and inexpensive to make and easy to install and use. The adjustable hinge comprising the present invention includes a hinge cup affixed to the first door of a combination of doors and a hinge arm pivotally connected to the hinge cup and having a threaded member receiving aperture. A spring is secured to the hinge cup and hinge arm and biases the hinge selectively to open and close positions. A face plate is secured to the second door of the combination and has an integral hinge arm engaging member with upstanding side walls and an elongated adjusting slot. The fixed hinge arm engaging member connects with the hinge arm by means of a threaded member such as a screw extending through an elongated adjusting slot in the engaging member. The threaded member threads within the threaded member receiving aperture of the hinge arm so that the engagement between the hinge arm and the hinge arm engaging member can be selectively loosened to change linearly (between the side walls) the position between the hinge arm and the hinge arm engaging member and tightened to fixedly secure the relationship and thereby make an adjustment between the first and second doors.

The hinge arm engaging member has a plurality of substantially parallel groves positioned near the adjusting slot to help the threaded member grip the surface of the hinge arm engaging member when tightened and thereby to ensure no relative movement between the hinge arm and the hinge arm engaging member.

From the foregoing, it can be seen that a p a objective of the present invention is to provide an adjustable hinge of the type described which provides for easily one location adjustment at each hinge to make the necessary alignment adjustments needed for supported doors.

Yet another objective of the present invention is to provide adjustable door hinges of the type described that is more reliable and functional than those previously available.

Yet still another objective of the present invention is to provide a mounting bracket of the type described that is simple in design and construction and economical for production.

This brief summary and the objectives outlined above focus on the more important features of the invention in order that the detailed description which follows may be better understood and that the present contribution to the art may be better appreciated. There are, of course, additional features of the invention that will be described hereinafter which will form the subject matter of the claims appended hereto. It is to be understood that the invention is not limited in its application to the details of construction and to the arrangement of the components set forth in the following description and drawings. The invention is capable of other embodiments and of being practiced and being carried out in various ways.

It is to be understood that the phraseology and terminology employed herein are for the purpose of description and are not to be regarded as limiting. Those skilled in the art will appreciate that the concept upon which this disclosure is based may readily by utilized for designing other structures, methods and systems for carrying out the several purposes of the invention. It is also to be understood that the abstract is neither intended to define the invention of the application, which is measured by its claims, nor to limit its scope in any way.

This summary and these objectives of the invention, along with the various features of novelty which characterize the invention, are pointed out with particularity in the claims annexed to and forming a part of this disclosure. For a better understanding of the invention, its operating advantages, and the specific objects obtained by its use, reference should be made to the accompanying drawings and descriptive matter in which like characters of reference designate like parts throughout the several views.

### BRIEF DESCRIPTION OF THE DRAWINGS

FIG. 1 is a side elevational and partial sectional view of the adjustable hinge comprising the present invention attached to side-by-side movable cabinet doors;

FIG. 2 is a perspective view of the adjustable hinge shown in FIG. 1;

FIG. 3 is a perspective and partial view of the use of the adjustable hinge comprising the present inventive concept in a kitchen cabinet setting, particularly at the intersection of two rows of kitchen cabinets; and

FIG. 4 is a top elevational, partial sectional view of the adjustable hinge comprising the present invention used on two adjacent side-by-side positioned doors within a kitchen corner location.

### DETAILED DESCRIPTION OF THE PREFERRED EMBODIMENT

Referring now to the drawings and particularly to FIG. 3, intersecting rows of kitchen cabinet 10, 12 intersect at substantially a 90 degree angle 4 thereby creating a somewhat awkward area of cabinet space (not shown) within the intersected rows. Utilizing this space efficiently is oftentimes done by the installation of a Lazy Susan device with an angularly spanning door across the intersection so that the rotating shelves can provide access to cabinet-housed items by simple rotation. In many instance, it is far more desirable to have additional floor space and to provide other means for accessing this somewhat awkward storing space.

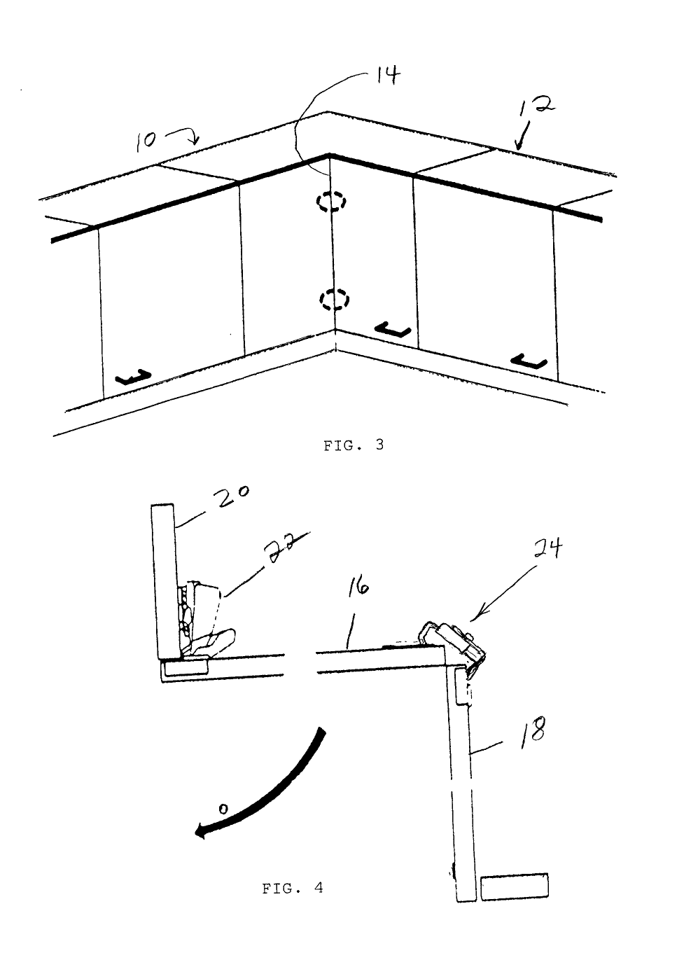

Accessing the storage space behind the intersection 14 shown in FIG. 3 can be done by the use of movably connected adjacent doors 16, 18 (FIG. 4) which are may be connected by the adjusting hinge of the present invention and in combination are connected to a supporting surface 20 by a conventional hinge 22. In operation, doors 16, 18 are normally fixed in a closed relationship at a 90 degree angle like the relationship shown in FIG. 4 and are maintained in that relationship by the hinge comprising the present invention generally designated 24. Hinge 24 permits relative movement between doors 16, 18 so that when the combination of doors is swung outwardly (see arrow) to expose the cabinet interior, they can be opened in substantially a straight line relationship with respect to each other to provide greater accessibility to the cabinet interior.

Hinge 24 is formed of hinge cup 26 positioned within a recess 28 of door 16 and a hinge arm 30 pivotally affixed to cup 26 in a conventional manner and having a threaded member receiving aperture 32 formed therein. A conventional spring 34 is secured to hinge cup 26 and hinge arm 30 and biases hinge arm 30 selectively to open and close positions reached when doors 16, 18 are moved outwardly while being supported by hinge 22.

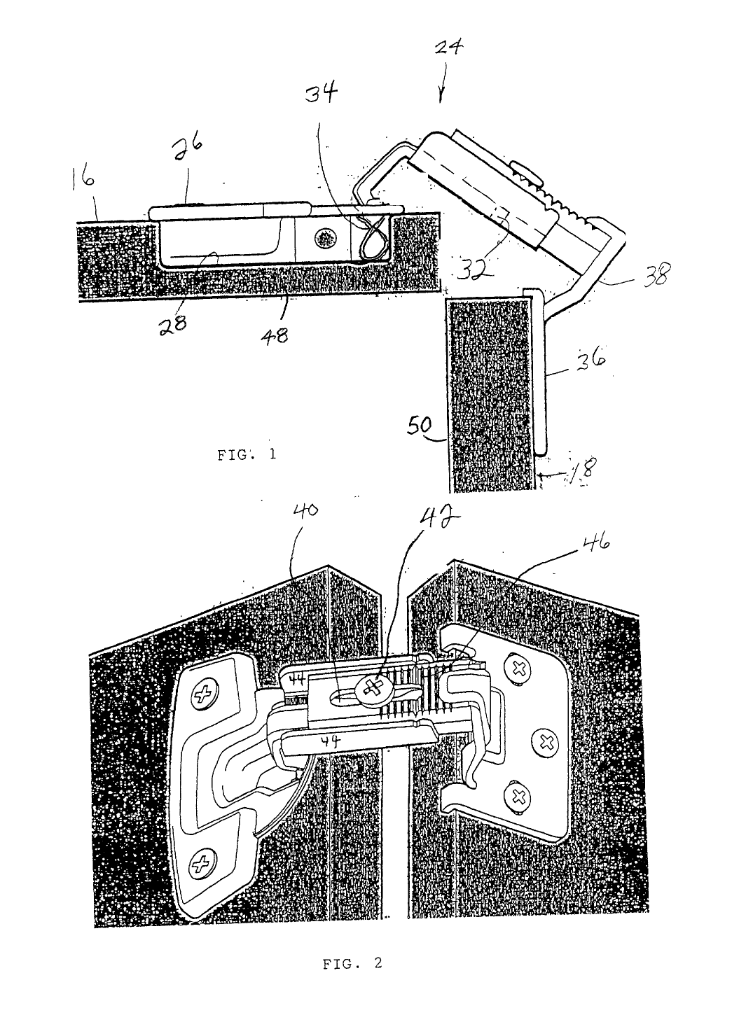

A base plate 36 is secured to door 18 as a surface mounted fixture and has a fixed hinge arm engaging member 38 extending therefrom. Engaging member 38 has an elongated adjusting slot 40 (FIG. 2) and two upstanding side walls 44. Member 38 is cooperatively received by hinge arm 30 so that a threaded member 42 can Mend through slot 40 and threadably connect with threaded aperture 32.

Hinge arm 30 cooperatively receives hinge arm engaging member 38 within the track formed with side walls 44 in a manner best shown in FIG. 2. The relationship between the two members 30, 38 is telescopic so that member 38 slides within the sides 44 of hinge arm 30 in a straight line (linear) direction consistent with the length and direction of the elongated adjusting slot 40 positioned directly over threaded member receiving aperture 32. When it is necessary to adjust the movable relationship between door 16, 18 threaded member 32 is loosened and hinge arm engaging member is moved linearly as needed within the walls 44 of hinge arm 30. When the correct adjustment is made, threaded member 42 is tightened and doors 16, 18 are maintained in a fixed relationship with each other.

Hinge arm engaging member 38 is provided with a plurality of substantially parallel groves 46 that serves to help threaded member 42 grip the surface of hinge arm engaging member 38.

Hinge 24 when positioned to hold two movable side-by-side positioned doors 16, 18 is not viewable on the front faces 48, 50 of doors 16, 18. The dotted oval representation in FIG. 3 is to describe the location of hinges 24 but is not intended to reflect the appearance of those hinges.

From the preceding description, it can be seen that the adjustable hinge comprising the present invention and individual components therefore have been provided that will meet all of the advantages of prior art devices and offer additional advantages not provided by such devices. With respect to the foregoing description, the optimum dimensional relationship to the parts of the invention including variations in size, shape, materials, form, function, and manner of operation, use and assembly are deemed readily apparent to those skilled in the art, and all equivalent relationships illustrated in the drawings and described in the specification are intended to be encompassed herein.

The foregoing is considered illustrative only of the principles of the invention. Since numerous modifications and changes will readily occur to those skilled in the art, it is intended not to limit the invention to the precise description and operation of the embodiment shown. All suitable modifications and equivalents that fall within the scope of the appended claims are deemed within the present inventive concept.

What is claimed is:

1. An adjustable door hinge for mounting a door on a supporting member comprising: a hinge cup affixed to the supporting member; a hinge arm pivotally affixed to the hinge cup and having a threaded member receiving aperture therein; spring means engaging the hinge cup and hinge arm biasing the hinge arm selectively to open and close positions; a base plate separate from the hinge arm secured directly to an adjacent structure and having an integral hinge arm engaging member extending therefrom, the engaging member having upstanding side walls forming a hinge arm receiving track, an elongated adjusting slot and cooperatively receiving the hinge arm within the formed receiving track; and a threaded member extending through the elongated adjusting slot and threadably engaging the hinge arm threaded receiving aperture, the threaded engagement between the hinge arm and the hinge arm engaging member being selectively loosened to adjust the relationship between the hinge arm and the hinge arm engaging member by moving the hinge arm linearly within the formed receiving track and tightened to fixedly secure the relationship and thereby adjust the position of the door with respect to the supporting member.

2. The hinge as claimed in claim 1 wherein the hinge arm engaging member has a plurality of substantially parallel grooves proximate the elongated adjusting slot.

3. The hinge as claimed in claim 1 wherein the supporting member is a door.

4. The hinge as claimed 2 wherein the adjacent structure is a door.

5. The hinge as claimed in claim 2 wherein the supporting member is a door.

6. The hinge as claimed in claim 2 wherein the adjacent structure is a door.

7. An adjustable hinge for joining a combination of doors in a side-to-side relationship comprising: a hinge cup affixed to the first door of a combination of doors; a hinge arm pivotally affixed to the hinge cup and having a threaded member receiving aperture therein; spring means engaging the hinge cup and hinge arm and biasing the hinge arm selectively to open and close positions; a base plate separate from the hinge arm secured directly to the second door of a combination of doors and having an integral hinge arm engaging member extending therefrom, the engaging member having upstanding side walls forming a hinge arm receiving track, an elongated adjusting slot and cooperatively receiving the hinge arm within the formed receiving track; and a threaded member extending through the elongated adjusting slot and threadably engaging the hinge arm threaded receiving aperture, the threaded engagement between the hinge arm and the hinge arm engaging member being selectively loosened to adjust the relationship between the hinge arm and the hinge arm engaging member by moving the hinge arm linearly within the formed receiving track and tightened to fixedly secure the relationship and thereby adjust the position of the first and second doors with respect to each other.

8. The hinge as claimed in claim 7 wherein the hinge arm engaging member has a plurality of substantially parallel grooves proximate the elongated adjusting slot.

9. The hinge as claimed in claim 7 wherein the hinge is not viewable on the front face of the doors.

10. The hinge as claimed in claim 1 wherein the adjusting movement between the hinge arm and the hinge arm engaging member is confined by the side walls of the hinge arm receiving track to movement along a straight line consistent with the length and direction of the elongated adjusting slot.

11. The hinge as claimed in claim 7 wherein the adjusting movement between the hinge arm and the hinge arm engaging member is confined by the side walls of the hinge arm receiving track to movement along a straight line consistent with the length and direction of the elongated adjusting slot.
